(19) United States
(12) Patent Application Publication
(10) Pub. No.: US 2025/0370743 A1
(43) Pub. Date: Dec. 4, 2025

(54) AUTOMATED SOFTWARE PACKAGE RELEASE MANAGEMENT

(71) Applicant: Microsoft Technology Licensing, LLC, Redmond, WA (US)

(72) Inventors: Rathi KARTHEEK, Cupertino, CA (US); Jerry Song KIM, Sammamish, WA (US); Scott Andrew FUDALLY, Redmond, WA (US); Kevin David POGUE, Duvall, WA (US); Hamza MUSTAFA, Redmond, WA (US); Francisco Cantú de la GARZA, Sammamish, WA (US); Vikas AHLUWALIA, Redmond, WA (US); Christina Marie SCHWAB, Spring, TX (US)

(21) Appl. No.: 18/677,516

(22) Filed: May 29, 2024

(51) Int. Cl. G06F 8/71; G06F 8/60

(52) U.S. Cl. CPC G06F 8/71; G06F 8/60

(57) ABSTRACT

Methods, systems, and computer program products are provided for automated software package release management. Software package development, testing, and release information is automatically captured, aggregated, organized and stored for accessibility and association with released software packages. Automated software package information management increases productivity and accuracy by removing most manual notation tasks from developers, testers, approvers, etc. A software release manager (SRM) may perform automated information collection, aggregation, approval management, compliance checking, change log generation, package compare, package deployment, notification, etc. for multiple software packages. For example, software package information can be distributed in notifications or accessed individually in a user interface. Users can make menu selections or query the software package manager, for example, to automatically and quickly determine and indicate software package-related information, such as the differences between released or unreleased packages, project status, approvals, test results, compliance, component change histories, etc.

### BACKGROUND

In software engineering, a software development process is a process of planning and managing software development across a or software development life cycle (SDLC). The software development process typically involves dividing software development work into smaller, parallel, or sequential steps or sub-processes to improve design and/or product management. Specific deliverables and artifacts may be pre-defined and subsequently created and completed by a project team to develop or maintain a software application. Software packages often combine many different components that are developed, tested, revised, and tested again prior to releasing the package for review or as a product. Some components may be used in multiple packages. Developers, testers, managers, and others involved in the development process may notate the development, testing, and release process over time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for automated software package release management. Software package development, testing, and release information is automatically captured, aggregated, organized, and stored for accessibility and association with released software packages. Automated software package information management increases productivity and accuracy by reducing manual notation tasks for developers, testers, approvers, etc. In aspects, a software release manager (SRM) is configured to perform one or more of automated information collection, aggregation, approval management, compliance checking, change log generation, package compare, package deployment, notification, etc., for one or more software packages. Software package information can be distributed in notifications or accessed individually in a user interface. Users are enabled to make menu selections or query the software package manager to automatically and quickly determine and indicate software package-related information, such as the differences between released or unreleased packages, project status, approvals, test results, compliance, component change histories, etc.

In one aspect, a software release manager (SRM) comprises a data manager configured to automatically obtain and store information indicative of change, testing, and release of a software package. The SRM includes a releaser configured to automatically generate the information indicative of the release of the software package for each release of the software package. The SRM includes a dashboard manager configured to provide a user interface for an authorized user to access the stored information indicative of change, testing, and release of the software package.

In further aspects, a notifier is configured to automatically notify configured recipients about the information indicative of change, testing, and release of a software package in response to a configured notification trigger. An approval manager is configured to automatically manage the release of the software package comprising managing an approval process to obtain approval of the software package from the configured recipients. A compliance checker is configured to automatically determine whether components in the software package comply with configured release criteria. A change log generator is configured to automatically maintain a history of changes to components in the software package. A package comparer is configured to automatically determine differences between components in different released or pre-released software packages or in different releases of the same software package. An aggregator is configured to automatically combine information about each component in the software package received from multiple sources or at different times. A package deployer is configured to automatically deploy the released software package to configured destinations.

In another aspect, a method comprises providing a data manager that: automatically obtains and stores information indicative of change, testing, and release of each of a plurality of software packages; provides a releaser that automatically generates the information indicative of the release of each of the plurality of software packages for each release of each of the plurality of software packages; and provides a dashboard user interface that presents users with the stored information indicative of change, testing, and release of each of the plurality of software packages.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example computing environment for zero touch release software, according to an embodiment.

FIG. 2 shows a block diagram of an example computing environment for automated software package release management, according to an embodiment.

FIG. 3 shows a block diagram of an example of components in an SRM dashboard manager, according to an embodiment.

FIG. 4 shows a block diagram of an example of components in an SRM releaser, according to an embodiment.

FIG. 5 shows a flowchart for implementing automated software package release management, according to an example embodiment.

FIG. 6 shows an example of a graphical user interface displayed when a user interacts with the SRM dashboard manager.

FIGS. 7A-7C shows flowcharts for implementing automated software package release management, according to example embodiments.

FIG. 8 shows a block diagram of example computing devices that may be used to implement example embodiments.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

A software package is a data structure containing a computer program and metadata for its deployment. A software package may have the form of an image, such as an archive file that contains the metadata and software components that make up the program code of the software package. The software package metadata typically includes a package description, a package version, and one or more dependencies (other computer code/software packages that need to be installed beforehand). Software packages often combine many different components that are developed, tested, revised, and tested again prior to releasing the software package for review or as a product. Some components may be used in multiple software packages. Developers, testers, managers, and others involved in the process of software development may notate the development, testing, and release process over time. However, manual notation is very time-consuming, often fails to capture all important information, and/or may include erroneous information.

Embodiments are described herein for a software release process (e.g., for internal or external release) that is automated with intelligent indexing of software data for automated collection and presentation of software release information. Releasable software can be generated from components when ready to deploy for use. All components can be combined into a single image to make a release for deployment with all accompanying release information. Automation supports various product teams to review, verify, validate, and provide additional context for a release image.

Automation of processes involved in releasing software packages provides users with a data driven process for insights into every component that goes into building software package release images. Automated management indexes and tracks every component in a (e.g., centralized) database with details for development, testing, release, ownership information, work items, bugs resolved, and other data. Automated software package release management automatically joins data from different sources, reducing information management duties and making data available on demand.

An automated software package release manager may be used daily. Each day various teams may fix bugs, add features, and resolve issues. There may be a release and testing conducted on a daily basis to validate component fixes collectively with other components. A build team may handle each release. A build team integrates all the components together in each release, confirms component validity, creates the image, etc., e.g., on a daily basis. There may be multiple testing teams (e.g., hardware testing team, electrical testing team) that focus on different feature sets who test daily fixes.

A software package may include, for example, hundreds of smaller pieces of software (e.g., components). One or more components may change each day. Each change is provided to the automated software package release management tool. Data collected indicates what changed, why it changed, what it fixes, etc. The data is collected and stored automatically without manual entry. All components and subcomponents are monitored in association with the configured software package.

According to embodiments, an automated software package release manager can manage many software packages simultaneously, e.g., in parallel. There may be some components that are used in multiple software packages. Each product team can use the user interface(s) provided by the manager to select which versions of the components are used in software packages (e.g., products).

An automated software package release manager can validate a wide variety of software (e.g., drivers) and firmware (FW) components.

An automated software package release manager can be implemented as platform, product, and component agnostic.

Users can access an automated software package release manager on a remote server (e.g., as a WebApp) for universal availability, which avoids downloading and installation dependencies.

Accordingly, methods, systems, and computer program products are provided for automated software package release management. Software package development, testing, and release information is automatically captured, aggregated, organized and stored for accessibility and association with released software packages. Automated software package information management increases productivity and accuracy by removing most manual notation tasks from developers, testers, approvers, etc. A software release manager (SRM) may perform automated information collection, aggregation, approval management, compliance checking, change log generation, package compare, package deployment, notification, etc. for multiple software packages. For example, software package information can be distributed in notifications or accessed individually in a user interface. Users can make menu selections or query the software package manager, for example, to automatically and quickly determine and indicate software package-related information, such as the differences between released or unreleased packages, project status, approvals, test results, compliance, component change histories, etc.

In one aspect, a software release manager (SRM) comprises a data manager (e.g., a data ingester and a database) configured to automatically obtain and store information indicative of change, testing, and release of a software package (e.g., for each component in each of a plurality of software packages). The SRM includes a releaser configured to automatically generate the information indicative of the release of the software package for each release of the software package. The SRM includes a dashboard manager configured to provide a user interface for authorized users to access the stored information indicative of change, testing, and release of the software package.

A notifier can be configured to automatically notify configured recipients about the information indicative of change, testing, and release of a software package in response to a configured notification trigger. An approval manager can be configured to automatically manage the release of the software package comprising managing an approval process to obtain approval of the software package from the configured recipients. A compliance checker can be configured to automatically determine whether components in the software package comply with configured release criteria (e.g., code query language (QL), flighting compliance, symbol checking, code QL static analysis, configuration (INF file) verifier). A change log generator can be configured to automatically maintain a history of changes to components in the software package. A package comparer can be configured to automatically determine differences between components in different released or pre-released software packages or in different releases of the same software package. An aggregator can be configured to automatically combine information about each component in the software package received from multiple sources or at different times. A package deployer configured to automatically deploy the released software package to configured destinations.

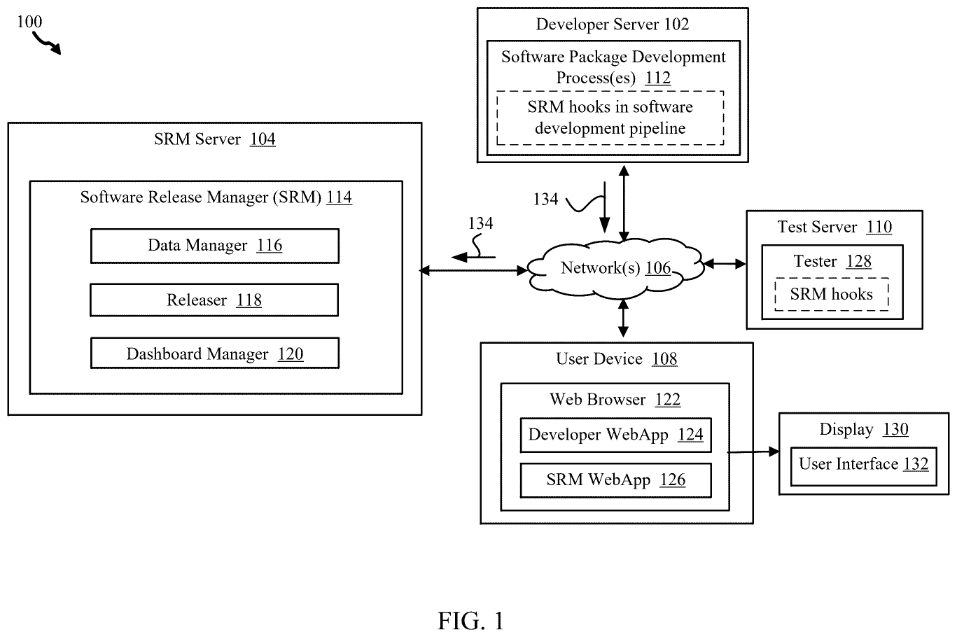

These and further embodiments may be configured in various ways and implemented in a variety of systems/environments. For example, FIG. 1 shows a block diagram of an example computing environment 100 for zero touch release software, according to an embodiment. Computing environment 100 is one of many possible examples of computing environments applicable to embodiments. As shown in FIG. 1, computing environment 100 includes a developer server 102, a software release manager (SRM) server 104, a user device 108, and a test server 110 coupled by one or more network(s) 106. Developer server 102 includes software package development process(es) 112 with SRM hooks (e.g., inserted program code) in software development pipeline. User device 108 includes a web browser 122, a developer Web application (WebApp) 124, an SRM WebApp 126, and a display 130. Test server 110 includes a tester 128. SRM server 104 includes a software release manager (SRM) 114, which includes a data manager 116, a releaser 118, and a dashboard manager 120. These components of environment 100 are described in further detail as follows.

As shown in FIG. 1, developer server 102, software release manager (SRM) server(s) 104, user device 108, and test server 110 are communicatively coupled by one or more networks 106 in support of touchless software package release management. Network(s) 106 may include one or more public access and/or restricted (e.g., private) access networks, which may be wired and/or wireless. Network(s) 136 may include, for example, one or more of any of a local area network (LAN), a wide area network (WAN), a personal area network (PAN), a combination of communication networks, such as the Internet, and/or a virtual network. In an implementation, remote computing device(s) 102, server(s) 104, and agent/host computing device 108 communicate via one or more application programming interfaces (APIs), and/or according to other interfaces and/or techniques. Developer server 102, SRM 104, user device 108, and test server 110 include one or more network interfaces that enable communications between devices. Examples of such a network interface, wired or wireless, may include, for example, an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

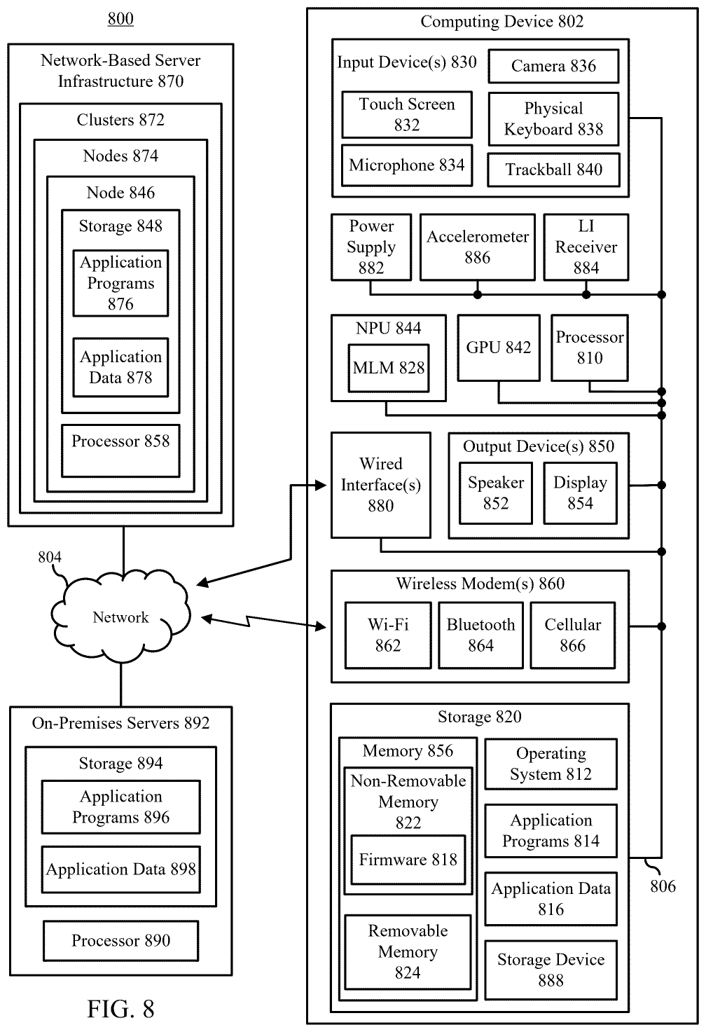

User device 108 may be any type of stationary or mobile computing device, including a mobile computer or mobile computing device (e.g., a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server. User device 108 may include one or more applications, operating systems, virtual machines (VMs), storage devices, etc., that may be executed, hosted, and/or stored therein or via one or more other computing devices via network(s) (not shown). An example computing device with example features is presented in FIG. 8. Note that any number of user devices 108 may be present in environment 100.

User device 108 executes one or more processes in one or more computing environments. A computing environment is any computing environment (e.g., any combination of hardware, software, and firmware). A process is any type of executable (e.g., binary, program, application) that is being executed by a computing device. A process executed by user device 108 includes Web browser 122. Web browser 122 processes client-side code from developer server 102 represented as developer WebApp 124, which provides a user interface 132 (e.g., displayed by display 130) for users of user device 108 to interact with software package development process(es) 112, and from SRM server 104 represented as SRM WebApp 126, which provides a user interface 32 for users of user device 108 to interact with SRM 114.

For example, developer WebApp 124 provides users (e.g., software developers) with user interface 132 to create, view, and edit software components that are combined into a software package released as a product. Additionally or alternatively, SRM WebApp 126 provides users (e.g., software developers, project managers, test engineers) with user interface 132, generated by dashboard manager 120, to perform operations related to software packages (e.g., configure, search, view, select, compare, schedule, release). For example, users can see the status of packages, select components for a package, release a package, compare differences between packages, view release dates, components, component change history, test results, ownership, etc., configure notifications, generate reports). Display 130 may be any suitable type of display device for displaying user interface 132, including those described below with respect to FIG. 8.

Developer server 102 comprises one or more computing devices, servers, services, local processes, remote machines, web services, etc. Developer server 102 may include any type of stationary or mobile computing device. In an example, developer server 102 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for automated software package release management. Developer server 102 may be implemented as a plurality of programs executed by one or more computing devices. Developer server 102 is not limited to physical machines, but may include other types of machines or nodes, such as a virtual machine, that are executed in physical machines.

Developer server 102 executes one or more processes. A process executed by developer server 102 includes server-side code for developer WebApp 124. Another process executed by developer server 102 includes software package development process(es) 112, which may be configured for (e.g., linked to) SRM 114. This configuration (e.g., linking) may be referred to as onboarding SRM 114 to perform automated software package release management of software package components developed using software package development process(es) 112. In some examples, SRM 114 can be integrated into software package development process(es) 112. In some examples, hooks (e.g., program code) can be added to software package development process(es) 112 to cause the process(es) 112 to automatically report information to data manager 116 regarding software package components. Hooking involves the interception of function calls, system events, communication messages, etc. The program code inserted to perform an interception is referred to as a “hook.”

Software package development process(es) 112 are processes configured to enable the creating of newer versions of package components. Hooks in the process of building a newer version push the data regarding a build into data manager 116. Hooks at the end of the build generation push the new data about the build into data manager 116. Hooks can indicate what types of information are reported to data manager 116, such as all package components (e.g., and subcomponents), changes to components, identification of people authorized for each package and components thereof, etc. Information reported to data manager 116 may include, for example, commit information, bugs fixed, tasks completed, etc. Data manager 116 can perform a recursive deep model that iterates to collect information across different layers.

SRM server 104 comprises one or more computing devices, servers, services, local processes, remote machines, web services, etc. SRM server 104 may be any type of stationary or mobile computing device. In an example, SRM server 104 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for automated software package release management. SRM server 104 may be implemented as a plurality of programs executed by one or more computing devices. SRM server 104 is not limited to a physical machine, but may include other types of machines or nodes, such as a virtual machine, that are executed in physical machines.

SRM server 104 executes one or more processes. A process executed by SRM server 104 includes server-side code for SRM WebApp 126. Another process executed by SRM server 104 includes software release manager (SRM) 114.

SRM 114 automatically captures, aggregates, organizes, and stores software package development, testing, and release information for accessibility and association with released software packages. SRM 114 increases productivity and accuracy by removing most manual notation tasks from developers, testers, approvers, etc. A software release manager (SRM) performs, for example, automated information collection, aggregation, approval management, compliance checking, change log generation, package compare, package deployment, notification, etc. for multiple software packages. For example, software package information can be distributed in notifications and/or accessed individually in user interface 132. Users of user device 108 can make menu selections or query SRM 114, for example, to automatically and quickly determine and indicate software package-related information, such as the differences between released or unreleased packages, project status, approvals, test results, compliance, component change histories, etc. for selected software packages created using software package development process(es) 112.

As shown by example in FIG. 1, SRM 114 includes data manager 116, releaser 118, and dashboard manager 120. Other implementations can include the same or different, more or fewer components.

Data manager 116 is configured to automatically obtain and store information indicative of change, testing, and release of each software package. Regardless of techniques used for information collection by data manager 116 from software package development process(es) 112, SRM 114 is configured to automatically collect information about the development, testing, and release of software packages. The information indicative of change, testing, and release of the software package can be indicative of change, testing, and release of components in the software package. The software packages are developed in a software package development process(es) 112 (e.g., a development pipeline) associated with the SRM 114. The association can comprise hooks in the software package development process(es) 112 causing automated reporting of the information indicative of change of components in the software package to data manager 116 in SRM 114.

Releaser 118 is configured to automatically generate the information indicative of each release of each software package.

Dashboard manager 120 is configured to provide user interface 132 for authorized users of user device 108 to access the stored information indicative of change, testing, and release of the software package.

In an example, releaser 118 can be used to generate daily releases of one or more software packages built using current versions of multiple components (e.g., hundreds of components). Dashboard manager 120 can be used to schedule daily testing of released software packages. Data manager can receive and associate test results with respective software packages for review using dashboard manager 120.

SRM 114 or components thereof, e.g., data manager 116, releaser 118, dashboard manager 120, etc. can include components or subcomponents that perform SRM-related operations.

For example, SRM 114 can include a notifier configured to automatically notify configured recipients about the information indicative of change, testing, and release of a software package, e.g., in response to satisfaction of a configured notification trigger, such as a release of a software package. A notification configuration can indicate the communication channels on which notifications are to be broadcasted and the target audience for each of those channels. Such a configured notification trigger enables configurable triggers for notification by SRM 114, as well as the recipients of those notifications, the communication channels over which such notifications are provided, and of further notification factors, enabling flexibility and varied capabilities for configurations on different platforms with corresponding communication mechanisms/protocols.

For example, SRM 114 can include an approval manager configured to automatically manage the release of each software package. Approval management can include managing an approval process to obtain approval of each software package from each configured recipient, such as in a release ring increasing in breadth of release at each stage of release.

For example, SRM 114 can include a compliance checker configured to automatically determine whether the components in each software package comply with configured release criteria (e.g., code query language (QL), flighting compliance, symbol checking, code QL static analysis, configuration (INF file) verifier).

For example, SRM 114 can include a change log generator configured to automatically maintain a history of changes to components in each software package.

For example, SRM 114 can include a package comparer configured to automatically determine differences between components in different released or pre-released software packages or in different releases of the same software package.

For example, SRM 114 can include an aggregator configured to automatically combine information about each component in each software package received from multiple sources or at different times.

For example, SRM 114 can include a package deployer configured to automatically deploy the released software package to configured destinations.

For example, SRM 114 can include a test manager configured to configure testing of software packages with tester 128 operated by test server 110. For example, a user can use SRM 114 to configure the return of test results to SRM 114, schedule a test time, schedule a notification of completion, etc.

Test server 110 comprises one or more computing devices, servers, services, local processes, remote machines, web services, etc. Test server 110 may be any type of stationary or mobile computing device. In an example, test server 110 may comprise a server located on an organization's premises and/or coupled to an organization's local network, a remotely located (e.g., third party) server, a cloud-based server (e.g., one or more servers in a distributed manner), or any other device or service that may host, manage, and/or provide resource(s) for automated testing of software packages, which may be configured to operate with SRM 114. Test server 110 may be implemented as a plurality of programs executed by one or more computing devices. Test server 110 is not limited to physical machines, but may include other types of machines or nodes, such as a virtual machine, that are executed in physical machines.

Test server 110 executes one or more processes. A process executed by test server 110 includes tester 128. Tester 128 can include, for example, one or more automated test scripts to test the performance of software packages on targeted computing environments. Tester 128 can be configured to generate test results for each test or set of tests, which may be returned to SRM server 104, for example, for handling by data manager 116 to allow access to the test results using dashboard manager 120. In some examples, a test request to tester 128 may indicate where test results should be returned (e.g., to data manager 116). In some examples, tester 128 may include SRM hooks that cause the automated reporting of indicated test results to data manager 116.

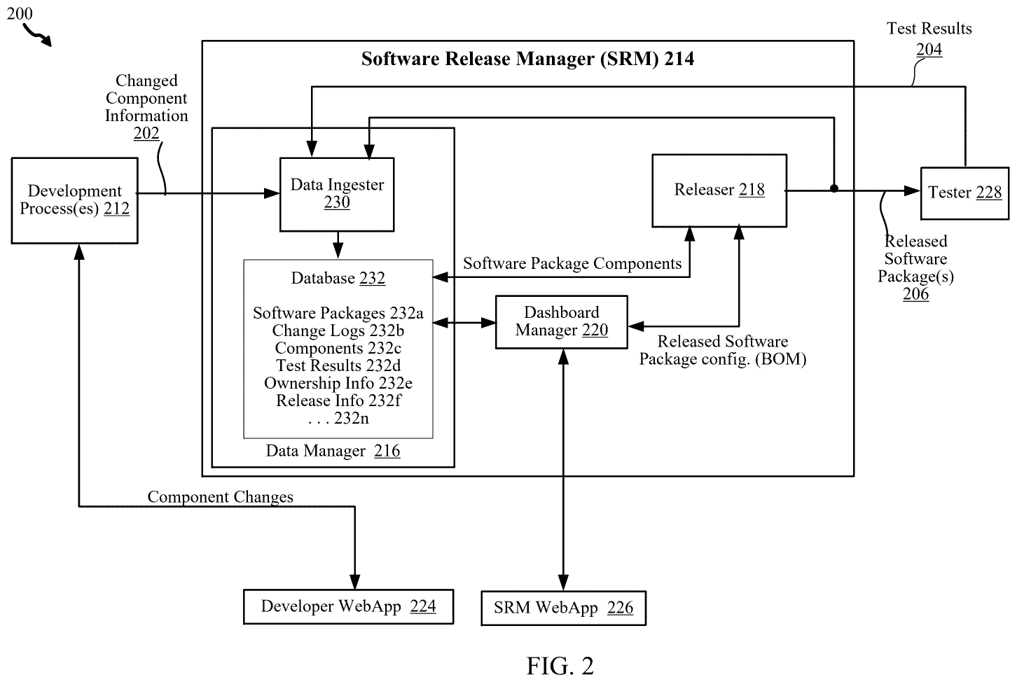

SRM 114 may be implemented in various ways, in embodiments. For instance, FIG. 2 shows a block diagram of an example computing system 200 for automated software package release management, according to an embodiment. Example computing system 200 presents one of many possible examples of computing systems. As shown in FIG. 2, computing system 200 includes one or more development process(es) 212, a SRM 214, a tester 226, a developer WebApp 222, and a SRM WebApp 224. SRM 214 is an example of SRM 114 of FIG. 1, and includes a data manager 216, a releaser 218, and a dashboard manager 220. Data manager 216 includes a data ingester 230 and a database 232. These and further components of system 200 are described in further detail as follows.

Developer WebApp 224 provides a user interface (e.g., user interface 132 of FIG. 1) for users (e.g., of user device 108) to interact with software package development process(es) 212. For example, developer WebApp 124 provides users (e.g., software developers) with a user interface to create, view, and edit software components that are combined into a software package. Developer WebApp 224 communicates component changes to development process(es) 212.

Development process(es) 212 is configured to report information about new and/or revised components to data ingester 230 in data manager 216 as changed component information 202. The configuration (e.g., linking) may be referred to as onboarding SRM 214 to perform automated software package release management of software package components developed using software package development process(es) 212. In some examples, SRM 214 can be integrated into software package development process(es) 212. In some examples, hooks can be added to software package development process(es) 212 to cause the process(es) 212 to automatically report configured information about software package components to data manager 216. Such hooks provide advantages, such as the automatic interception of function calls, system events, communication messages, etc., related to software package development, and the collection of information related thereto, for efficient and automatic reporting of detailed configured information about software package components to data ingester 230.

Software package development process(es) 212 includes a process of creating newer versions of package components. Hooks in the process of building the newer versions push the data into data ingester 230. Hooks at the end of the build generation push the new data about the build into data ingester 230. Hooks can indicate what types of information are reported to data ingester 230, such as all package components (e.g., and subcomponents), changes to components, identification of people authorized for each package and components thereof, etc.

SRM 214 automatically captures, aggregates, organizes, and stores software package development, testing, and release information for accessibility and association with released software packages. SRM 214 performs, for example, automated information collection, aggregation, approval management, compliance checking, change log generation, package compare, package deployment, notification, etc. for multiple software packages. SRM 214 presents the information to users in notifications and/or in a user interface. SRM 214 can receive and respond to menu selections and user queries to automatically and quickly determine and indicate software package-related information, such as the differences between released or unreleased packages, project status, approvals, test results, compliance, component change histories, etc. for selected software packages created using software package development process(es) 212. As shown by example in FIG. 2, SRM 214 includes data manager 216, releaser 218, and dashboard manager 220.

Data manager 216 is configured to automatically obtain and store information indicative of change, testing, and release of each software package. Regardless of techniques used for information collection by data manager 216 (e.g., automatic pushing or pulling of data), data manager 216 is configured to automatically collect information about the development, testing and release of software packages (e.g., components in the software packages) developed in software package development process(es) 212. New/revised components 230 received by data manager 216 includes information indicative of change of components in software packages. As shown by example in FIG. 1, data manager 216 includes data ingester 230 and database 232.

Data ingester 230 is configured to automatically receive information (e.g., whether by pushing or pulling data) from multiple sources, such as new/revised components 230 from development process(es) 212, released software package information in released software package(s) 206 from releaser 218, and test results 204 from tester 228. Data ingester 230 may be implemented, for example, on one or more servers. Data ingester 230 may ingest software package information for many software packages developed by one or more individuals or companies. Data ingester may be configured to perform processing on one or more types of received information (e.g., prior to indexing and storage by database 232), for example, to aggregate data from multiple sources, to reduce the volume of information, to maintain security protocols configured by data owners, to maintain proper associations of components with one or more software packages, to prepare (e.g., format) data for one or more uses by operations that may be performed by dashboard manager 220, etc. Data ingester 230 provides (e.g., processed) data to database 232 for indexing and storage.

Database 232 receives (e.g., processed) data from data ingester 230. Database 232 may be operated by one or more database servers for data management, including processing queries received from dashboard manager 220, releaser 218, etc. Database 232 may be interfaced with (e.g., configured to communicate with) data ingester 230, dashboard manager 220, and releaser 218, for example, through APIs and/or by other mechanisms. Database 232 may communicate with data ingester 230, dashboard manager 220, and releaser 218 to receive information and provide information related to software package development, testing, and release. Database 232 may include a database management service (DBMS) configured to communicate (e.g., via network(s) 106) with data ingester 230, dashboard manager 220 and releaser 218. Database 232 DBMS may manage tables among one or more databases, provide a database schema, receive, schedule, and execute queries against tables, and send query results to dashboard manager 220 and releaser 218. Tables may be configured to store information for efficient access, such as software packages 232a, component change logs 232b, components 232c, test results 232d, ownership information 232e, release information 232f (e.g., release dates), authorized users, and so on.

SRM WebApp 226 provides a user interface for users (e.g., of user device 108) to interact with SRM 114. SRM WebApp 226 provides users (e.g., software developers, project managers, test engineers) with a user interface, such as dashboard manager 220 to perform operations related to software packages (e.g., configure, search, view, select, compare, schedule testing, release, schedule release management). For example, users can use SRM WebApp 226 to see a user interface provided by dashboard manager 220 to see the status of software packages, select components for a package, release a package, compare differences between packages, view release dates, components, component change history, test results, ownership, etc., configure notifications, generate reports, schedule testing, schedule release approval management, and so on).

Releaser 218 is configured to automatically generate the information indicative of each release of each software package in released software package(s) 206. Releaser 218 can be configured to interact with, for example, database 232, data ingester 230, tester 228, and dashboard manager 220. Releaser 218 can be configured to obtain software package components and information about software package components from database 232, e.g., according to software package components indicated/selected by a user using dashboard manager 220. Releaser 218 can be configured to send released software package information in released software package(s) 206 to data ingester 230. Releaser 218 can be configured to provide a testing configuration (e.g., indicated using dashboard manager 220) to tester 228. Releaser 218 can be configured to send released software packages 206 to tester 228 for testing (e.g., according to a testing schedule indicated using dashboard manager 220). In an example, releaser 218 can be used to generate daily releases of one or more software packages built using current versions of multiple components (e.g., hundreds of components). Accordingly, releaser 218 enables the automatic generation of information regarding releases generated by SRM 214 in an efficient manner that increases productivity and accuracy by reducing manual notation tasks for developers, testers, approvers.

Dashboard manager 220 is configured to provide a user interface for authorized users (e.g., of user device 108) to access the stored information indicative of change, testing, and release of the software package. Dashboard manager 220 can be configured to interact with, for example, database 232, releaser 218, tester 228 (e.g., through releaser 218), and SRM WebApp 226. Dashboard manager 220 provides a user interface to SRM WebApp 226 in which users can, for example, see the status of software packages, select components for a package, release a package, compare differences between software packages 232a, view software package release information 232f, components 232c in software packages, component change history (e.g., in change logs 232a), test results 232d/204 generated by tester 228 for software packages, software package ownership information 232e, further database information 232n, configure notification triggers and information included in notifications, generate reports, tables, graphs, etc., configure testing, schedule testing, schedule release approval management, and so on.

For example, a user can use dashboard manager 220 to indicate/select components in a software package. A user can select specific versions of each component in a set of components for a software package release. Dashboard manager 220 provides software package release build information to releaser 218. For example, dashboard manager 220 can be used to schedule daily testing of daily released software packages. Dashboard manager 220 requests information from database 232 (e.g., in the form of queries) to populate information displayed in SRM WebApp 226 for each authorized user and/or to respond to user searches/queries for information about software packages, components, test results, etc. The information displayed by SRM WebApp 226 may be user-specific, for example, given that each user may have different authorizations to view and edit various components and software packages.

Tester 228 can include, for example, one or more automated test scripts to test the performance of (e.g., released) software packages on one or more computing environments. Tester 128 can be configured to generate test results 204 for each test or set of tests. Test results 204 are provided to data ingester 230 to process and store in database 232 to allow access to the test results via automated notifications and/or through dashboard manager 120.

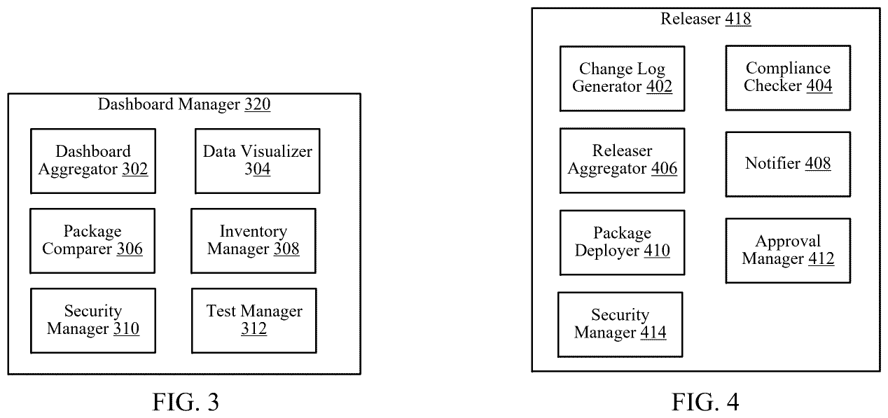

Dashboard managers 120 and 220 of FIGS. 1 and 2 can be implemented in various ways. For instance, FIG. 3 shows a block diagram of an example SRM dashboard manager 320, according to an embodiment. As shown in the example in FIG. 3, dashboard manager 320 includes dashboard aggregator 302, data visualizer 304, package comparer 306, inventory manager 308, security manager 310, and test manager 312. These features of dashboard manager 320 are described in further detail as follows.

Dashboard aggregator 302 is configured to aggregate data from multiple sources received at different times. For example, dashboard aggregator 302 can perform join operations that join multiple tables. Dashboard aggregator 302 may be configured to tag and untag data with various notations, such as to associate data with a software package, to indicate whether to discard data, do not use data, revoke data from being least known good, etc. Dashboard aggregator 302 can be performed as a background process that aggregates information from multiple sources and tables to derive requested data (e.g., requested via dashboard manager 320).

Data visualizer 304 includes data modeling tools to create graphs and other visualizations of data presented through dashboard manager 320, in reports, and/or in notifications. Aggregator 302 may perform back end operations while data visualizer 304 may perform front end operations.

Package comparer 306 is configured to automatically determine differences between components in different released or pre-released software packages or in different releases of the same software package. Package comparer 306 performs comparisons of selected software packages and/or components in software packages. For example, package comparer 306 compares a software bill of materials (BOM) for a first software package to a software BOM for a second software package or compares a software BOM for different versions of the same software package. Package comparer 306 can detect changes (e.g., additions and deletions) in drivers. Package comparer 306 can use intelligent tracking models that enable comparison across images. Thus, package comparer 306 enables the automatic generation of differences between software packages to inform end users of changes, updates, etc., in releases.

Inventory manager 308 is configured to allow users to manage the inventory of software packages and components therein that security manager 310 allows each user to view and/or manipulate. For example, inventory manager 308 generates information for user requests. Inventory manager 308 helps manage ownership and other software inventory. Inventory manager can be a branching work stream that allows users to associate software packages with owners. Ownership data for software packages provide other metadata, such as area subsystem description, repository, etc., component by component. Data may not be release specific, but during release the data may be used for associating users and subsystems with the change log, work item generation, commit information, bugs, fixes, etc.

Security manager 310 performs access control to software components, software packages, and related information (e.g., software assets). Security manager 310 manages user authorizations, such as access privileges for viewing or performing operations (e.g., editing, releasing, deploying, testing, reporting) related to software components, software packages, and associated information. Security manager 310 restricts what each user has access to in their respective dashboard manager 320. An administrator may control user authorizations in dashboard manager 320. An administrator may give assigned owners of software packages or components (e.g., software team lead) a different set of privileges than non-owners. Some users may be able to view and generate reports while others may be able to edit components, select a set of components for a software package release, configure a recipient list for notifications, and so on (e.g., team members with editing privileges and support staff limited to viewing and reporting privileges).

Test manager 312 is configured to allow authorized users to manage testing of software packages. Users interacting with dashboard manager 320 can configure and schedule testing for one or more software packages (e.g., with tester 228). Released software packages may be configured to proceed to testing by an automated test system (e.g., tester 228). The test and passing criteria for each test can be configured by one or more users (e.g., in the test team).

Releasers 118 and 218 of FIGS. 1 and 2 may be implemented in various ways. For instance, FIG. 4 shows a block diagram of an SRM releaser 418, according to an embodiment. As shown in the example in FIG. 4, releaser 418 includes change log generator 402, compliance checker 404, releaser aggregator 406, notifier 408, package deployer 410, approval manager 412, and security manager 414.

Change log generator 402 is configured to generate a detailed history of changes to components in each software package. Changes may indicate differences between specified versions of components or software packages, such as consecutive versions of one or more components. For example, change logs can indicate why each component in a software package was changed, what was changed, who changed it, and so on. Change log generator 402 can detect changes (e.g., additions, deletions) in drivers. Change log generator 402 can create automated machine driven release notes. Change log generator 402 thereby automatically generates change histories that inform about changes to software components in a software package, which may aid in, determining how up-to-date is the software package, identifying platforms compatible with the software package etc.

Compliance checker 404 is configured to perform one or more compliance checks, such as for the code QL, flighting compliance/discrepancies, symbol checking, configuration file (e.g., .INF file) verification, etc. Compliance checker 504 can be configured to detect flighting discrepancies for drivers, e.g., to help identify which driver/component is right for which hardware SKU. Compliance checker 404 can automatically test to confirm whether each tested computing environment correctly performs a wide variety of software (e.g., driver) functions. Compliance checker 404 may compare test results to configured testing compliance requirements. For example, a software package may be configured for release based on a testing compliance criteria of 98% pass rate in test results. Compliance checker 504 can generate information about which software functions are not being correctly performed. Compliance checker 404 can perform validation techniques across multiple dimensions to aggregate validation. Compliance checker 404 can use an auto recovery mechanism to suggest corrective actions and/or take corrective actions. For example, compliance checker 404 can perform software updates for the functions that are not correctly performed to correct the identified problems. Compliance checker 404 may be configured to decide whether to push a release process forward (e.g., to approval manager 412) based on the test results.

Releaser aggregator 406 is configured to aggregate information. Releaser aggregator 406 may access the database (e.g., database 232) for information, such as components in a software package configuration (e.g., BOM) configured using the dashboard.

Notifier 408 is configured to notify recipients upon satisfaction of notification triggers. For example, notifier 408 can be configured to send email notifications to a configured list of recipients that a package has been released and/or that test results are available. In an embodiment, notifier 408 receives as input contact information (e.g., email address, web conference identifiers, chat identifiers) (e.g., received at user interface 132 (FIG. 1) or other user interface) of entities to notify. A user (e.g., an admin or project owner) can configure one or more communication channels to send messages to one or more communication recipients based on one or more notification triggers. Information provided in notifications may be gathered by change log generator 402, compliance checker 404, and releaser aggregator 406. Various notifications may use different sets of communication channels and a recipient lists (e.g., audiences). For example, a ring release may have different sets of recipients for narrow to wide release for small to large groups performing release analyses.

Package deployer 410 is configured to deploy released software packages to one or more configured destinations. Package deployer 410 can present (e.g., via dashboard manager 120) a list of all possible destinations and receive user selections. Package deployer 410 can be configured to obtain package components, for example, from release aggregator 406. Package deployer 410 can be configured with an ability to upload released software packages to multiple (e.g., cloud) locations indicated by one or more users. In this manner, package deployer 410 deploys released software packages to configured destinations in an automated manner, which enables greater efficiency and scalability in deployment, as well as reducing manual effort.

Approval manager 412 is configured to manage a release process relating to configured approvals. In an embodiment, approval manager 412 receives as input names and contact information (e.g., email address) of the one or more approvers, which may be received at user interface 132 (FIG. 1) or other user interface. Approval manager 412 may pursue a configurable number of rings, layers or tiers of approval. Approval manager 412 may implement a first process for a first approval group to release an image and a second process for a second approval group to release the image. The groups may indicate in reviews an approval or disapproval in one or more categories. For example, a first group may evaluate a software package for a predefined amount of time, and then annotate the results of their experience(s). Approval manager 412 may then, e.g., if specified conditions are satisfied, send the software package to a second (e.g., larger) group for review for a period of time. For example, a software package making the rounds for approval (e.g., by approval manager 412) may have customized fields to accept a customized a set of data to be added to the release. Custom data may include known issues, special rules that need to be followed, confidentiality agreements, etc.

Security manager 414 is configured to enforce user access level (privilege enforcement) checks. Security manager 414 may deny access to completely unauthorized users. A user group may be broader than the developers group. For example, an admin or project owner may limit some users to viewing software packages and components while other users may have fewer restrictions and some users may have complete access with unlimited actions. Security manager 414 may enforce role level security in the database accessible through releaser 418.

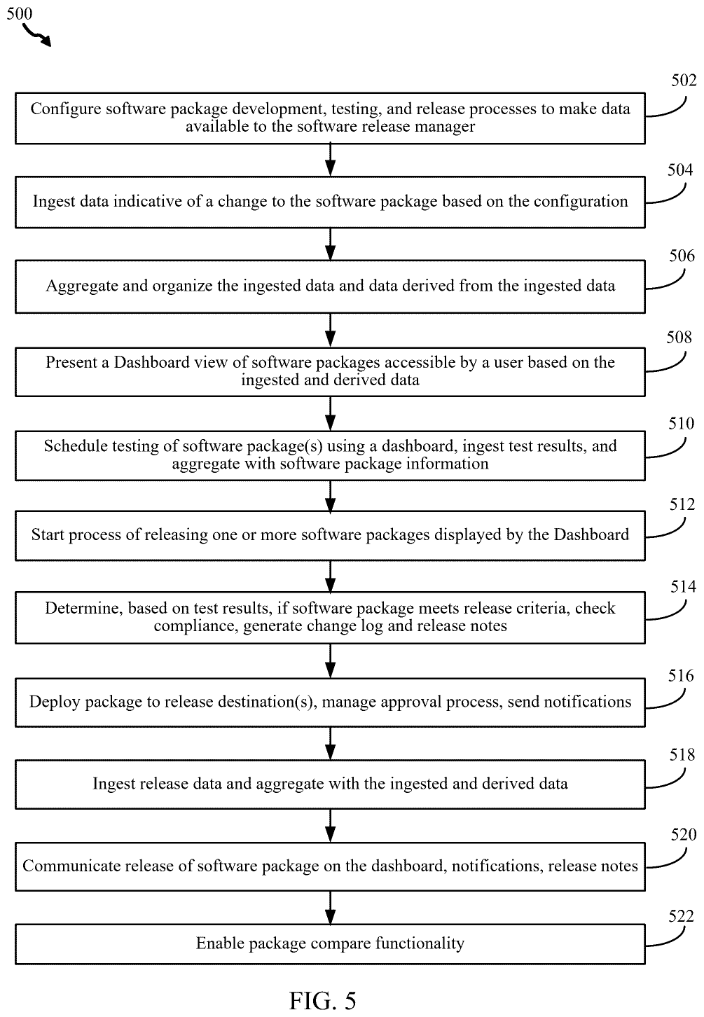

SRMs 114 and 214 of FIGS. 1 and 2 may operates in various ways in embodiments. For instance, FIG. 5 shows a flowchart 500 for implementing automated software package release management, according to an embodiment. Other structural and operational embodiments will be apparent to persons skilled in the relevant art(s) based on the description of flowchart 500. Note that there is no requirement that a method embodiment implement all of the steps illustrated in FIG. 5. In various implementations, steps may be added, removed, implemented in the alternative, e.g., in any combination or order. FIG. 5 is simply one of many possible embodiments. Flowchart 500 is described as follows with respect to FIGS. 1-4.

As shown in FIG. 5, in step 502, software package development, testing, and release processes may be configured to make data available to the software release manager. For example, as shown in FIG. 1, SRM hooks may be placed in software package development process(es) 112 and/or tester 128, with releaser 118 integrated in SRM 114. Other implementations may implement a variety of integrations and/or configurations to cause automated reporting to SRM 114 data manager 116.

In step 504, data indicative of a change to the software package may be ingested based on the configuration of the development software in 502. For example, as shown in FIGS. 1 and 2, software package development process(es) 112/212 can push data indicative of changes to software package components to data manager 116/216.

In step 506, the ingested data and data derived from the ingested data may be aggregated and organized. For example, as shown in FIGS. 1-4, data ingested and derived by data manager 116/216 (e.g., data ingester 230), and operations of components of dashboard manager 120/220/320 and releaser 118/218/418 may be aggregated and organized in database 232 for presentation in notifications, in dashboard manager 120/220/320, in release notes, etc.

In step 508, a dashboard view of software packages accessible by a user is presented based on the ingested and derived data. For example, as shown in FIGS. 1-4, dashboard manager 120/220/320 presents a user interface providing software package information pertaining to development, testing, and release from database 232 to authorized users. For example, when the user launches dashboard manager 120/220/320, a list of software packages the user has privileges for are shown. The user can select a software package. Dashboard manager 120/220/320 then displays in the user interface (e.g., for the chosen software package) visualizations generated by data visualizer 304, which includes the change history of the software package. Dashboard aggregator 302 aggregates/joins data from different tables in database 232 and/or multiple sources. Displayed data includes ingested and derived data produced by SRM 114/214. The user can select various components for component-level detail in various software packages.

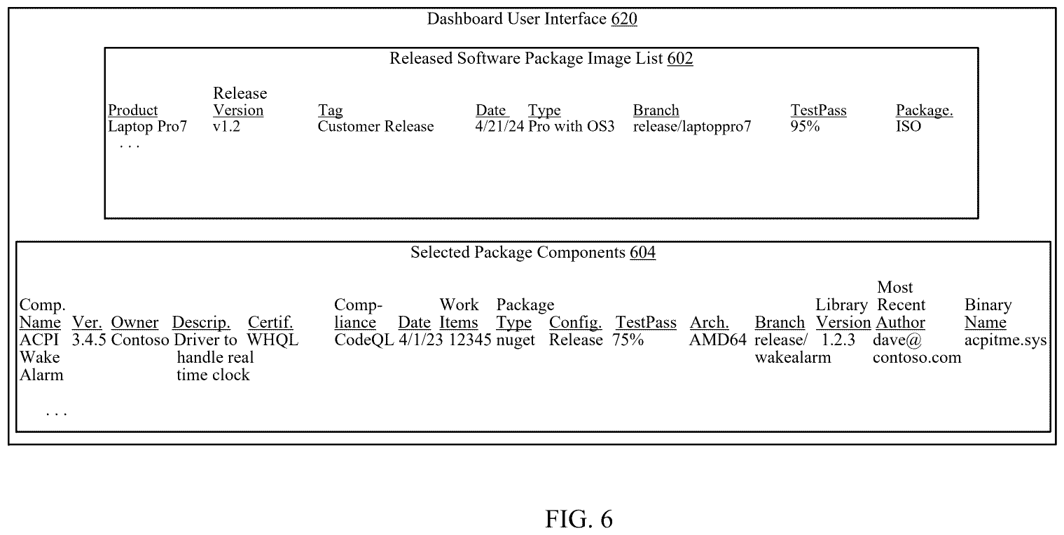

In embodiments, various user interfaces may be generated by dashboard managers 120 and 220 as a dashboard for user interaction. For instance, FIG. 6 shows an example of a user interface 620 for user interaction, according to an embodiment. As shown in the example in FIG. 6, dashboard 620 displays a selectable list of released software package images 602 and, e.g., for a selected package, a selectable list of software package components 604.

Referring back to flowchart 500 in FIG. 5, in step 510, testing of software package(s) is scheduled using the dashboard, and test results are ingested and aggregated with software package information. For example, as shown in FIGS. 1-4, a user interacting with dashboard manager 120/220/320 via a user interface can use test manager 312 to configure and schedule testing of software packages by tester 128/228. The testing configuration can specify that tester 128/228 should return test results to data manager 116/216 (e.g., data ingester 230), which processes and aggregates the test results with software package information in database 232.

In step 512, the process of releasing one or more software packages displayed by the dashboard can begin. For example, as shown in FIGS. 1-4, a user interacting with the user interface provided by dashboard manager 120/220/320 can select a package or configure a software BOM specifying a set of components for a software package release. The BOM is provided to releaser 118/218/418 to perform the selected software package release.

In step 514, a determination is made, based on test results, if the software package selected for release meets release criteria, a determination is made whether the software package meets compliance requirements, and a change log and release notes are generated. For example, as shown in FIGS. 1-4, releaser 118/218/418 processes the software package selected for release. Releaser aggregator 406 aggregates the data needed to make determinations about the release. Compliance checker 404 determines whether the components in the software package meet compliance requirements, such as for the code QL, flighting compliance/discrepancies, symbol checking, configuration file (e.g., .INF file) verification, and whether test results pass testing thresholds for release. Change log generator 402 generates a change log to associate with the software package release based on the aggregated information. Releaser 418 generates release notes to associate with the software package release.

In step 516, the software package is deployed to release destination(s), the approval process is managed, and notifications are sent to recipients. For example, as shown in FIGS. 1-4, releaser 118/218/418 processes the deployment and handles release management for the selected software package. Package deployer 410 deploys the software package based on the configured or indicated release procedure. Approval manager 412 manages the approval process for the various recipients of the managed release. Notifier 408 sends configured notifications to configured recipients based on satisfaction of configured notification triggers.

In step 518, the release data is ingested and aggregated with other ingested and derived, aggregated data associated with the released software package. For example, as shown in FIGS. 1-4, releaser 118/218/418 sends release information generated during the release process to data manager 116/216 (e.g., data ingester 230), which aggregates the release data with other ingested and derived software package data in database 232.

In step 520, the release of the software package is communicated on the dashboard, by notifications, and/or in release notes. For example, as shown in FIGS. 1-4, when users access dashboard manager 220, the generated dashboard displays release information associated with software packages users are authorized to see. Notifier 408 sends configured notifications (e.g., with release information, approval information, deployment information) to configured recipients based on satisfaction of configured notification triggers. Users can also view release notes associated with released software packages by selecting released software packages in a user interface generated by dashboard manager 120/220/320.

In step 522, package compare functionality may be enabled for the released package. For example, as shown in FIGS. 1-4, package comparer 310 in dashboard manager 320 may be enabled to perform a package compare of the recently released software package to other versions of the software package based on software package release information updated in database 232.

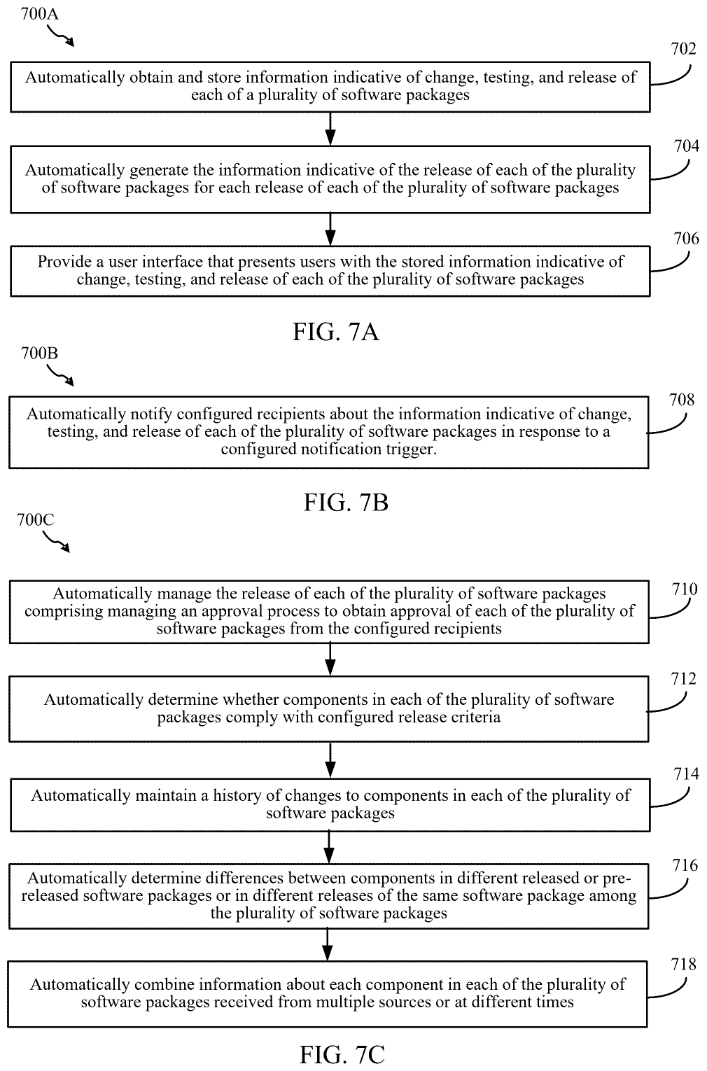

FIGS. 7A-7C show flowcharts 700A-700C for implementing automated software package release management, according to an example embodiment. Embodiments may operate in accordance with each of flowcharts 700A-700C. Flowchart 700A comprises steps 502-506. Flowchart 700B comprises step 508. Flowchart 700C comprises steps 710-718. However, other structural and operational embodiments will be apparent to persons skilled in the relevant art(s) based on the foregoing and following discussions. There is no requirement that a method embodiment implement all of the steps illustrated in FIGS. 7A-7C. In various implementations, steps may be added, removed, implemented in the alternative, e.g., in any combination or order. FIGS. 7A-7C are simply several of many possible embodiments. Flowcharts 700A-700C are described as follows with respect to FIGS. 1-6.

As shown in FIG. 7A, in step 702, information is automatically obtained and stored that is indicative of change, testing, and release of each of a plurality of software packages. For example, as shown in FIGS. 1-4, software package development process(es) 112/212, tester 128/228, and releaser 118/218/418 can be configured to provide data indicative of changes to software package components, test results, and release information to data manager 116/216. Data ingested and derived by data manager 116/216 (e.g., data ingester 230), and operations of components of dashboard manager 120/220/320 and releaser 118/218/418 may be aggregated and organized in database 232 for presentation in notifications, in dashboard manager 120/220/320, in release notes, etc.

In step 704, information is automatically generated indicative of the release of each of the plurality of software packages for each release of each of the plurality of software packages. For example, as shown in FIGS. 1-4, a user interacting with the user interface provided by dashboard manager 120/220/320 can select a package or configure a software BOM specifying a set of components for a software package release. The BOM is provided to releaser 118/218/418 to perform the selected software package release. Releaser 118/218/418 sends release information generated during the release process to data manager 116/216 (e.g., data ingester 230), which aggregates the release data with other ingested and derived software package data in database 232.

In step 706, a user interface is provided that presents users with the stored information indicative of change, testing, and release of each of the plurality of software packages. For example, as shown in FIGS. 1-4 and 6, dashboard manager 120/220/320 presents software package information pertaining to development, testing, and release from database 232 to authorized users. Displayed data includes ingested and derived data produced by SRM 114/214. For example, when the user launches dashboard manager 120/220/320, a list of software packages the user has privileges for are shown (e.g., as provided by the example in FIG. 6). The user can select a software package. Dashboard manager 120/220/320 displays (e.g., for the chosen software package) the components of the selected software package (e.g., as provided by the example in FIG. 6). The user can select various components for component-level detail in various software packages.

As shown in FIG. 7B, in step 708, configured recipients are automatically notified about the information indicative of change, testing, and release of each of the plurality of software packages in response to a configured notification trigger. For example, as shown in FIGS. 1-4, SRM 114/214 includes a notifier 408, which a user can configure to send notifications with information indicative of change, testing, and/or release of each of the plurality of software packages to configured recipients based on satisfaction of configured notification triggers. In examples, users may configure a notifier in a dashboard to automatically notify selected users with selected information.

As shown in FIG. 7C, in step 710, the release of each of the plurality of software packages is automatically managed, comprising managing an approval process to obtain approval of each of the plurality of software packages from the configured recipients. For example, as shown in FIGS. 1-4, approval manager 412 manages the approval process for the various recipients of the managed release of each software package.

In step 712, whether components in each of the plurality of software packages comply with configured release criteria is automatically determined. For example, as shown in FIGS. 1-4, compliance checker 404 determines whether the components in each software package meet compliance requirements, such as for the code QL, flighting compliance/discrepancies, symbol checking, configuration file (e.g., .INF file) verification, and whether test results pass testing thresholds for release.

In step 714, a history of changes to components in each of the plurality of software packages is automatically maintained. For example, as shown in FIGS. 1-4, change log generator 402 generates a change log to associate with the software package release based on the aggregated information.

In step 716, differences are automatically determined between components in different released or pre-released software packages or in different releases of the same software package among the plurality of software packages. For example, as shown in FIGS. 1-4, package comparer 306 performs comparisons of selected software packages and/or components in software packages. For example, package comparer 306 compares a software bill of materials (BOM) for a first software package to a software BOM for a second software package or compares a software BOM for different versions of the same software package. Package comparer 306 can detect changes (e.g., additions and deletions) in drivers. Package comparer 306 can use intelligent tracking models that enable comparison across images.

In step 718, information is automatically combined about each component in each of the plurality of software packages received from multiple sources or at different times. For example, as shown in FIGS. 1-4, dashboard aggregator 302 aggregates data from multiple sources received at different times. For example, dashboard aggregator 302 can perform join operations that join multiple tables. Dashboard aggregator 302 may be configured to tag and untag data with various notations, such as to associate data with a software package, to indicate whether to discard data, do not use data, revoke data from being least known good. Dashboard aggregator 302 can aggregate information from multiple sources and tables to derive requested data (e.g., requested via dashboard manager 320). Releaser aggregator 406 also aggregates information to perform a release. Releaser aggregator 406 may access the database (e.g., database 232) for information, such as components in a software package configuration (e.g., BOM) configured using the dashboard. By aggregating data from multiple sources, dashboard aggregator 302 collects data into a unified data structure for ease of use. Furthermore, by tagging/untagging data with various notations, release aggregator 406 indicates to a recipient of the data how to treat the data (e.g., whether to use or discard the data, associate the data, etc.), thereby relieving the end user of making the determination.

### III. Example Computing Device Embodiments

SRMs 114 and 214, data managers 116 and 216, releasers 118, 218, and 418, dashboard managers 120, 220, 320, and 620, software package development processes 112 and 212, testers 128 and 228, developer WebApps 124 and 224, SRM WebApps 126 and 226, data ingester 230, dashboard aggregator 302, data visualizer 304, package comparer 306, inventory manager 308, security manager 310, test manager 312, change log generator 402, compliance checker 404, releaser aggregator 406, notifier 408, package deployer 410, approval manager 412, and security manager 414, and flowcharts 500, 700A, 700B, and 700C are each implemented as computer program code/instructions configured to be executed in one or more processors and stored in a computer readable storage medium. Alternatively, SRMs 114 and 214, data managers 116 and 216, releasers 118, 218, and 418, dashboard managers 120, 220, 320, and 620, software package development processes 112 and 212, testers 128 and 228, developer WebApps 124 and 224, SRM WebApps 126 and 226, data ingester 230, dashboard aggregator 302, data visualizer 304, package comparer 306, inventory manager 308, security manager 310, test manager 312, change log generator 402, compliance checker 404, releaser aggregator 406, notifier 408, package deployer 410, approval manager 412, and security manager 414, and flowcharts 500, 700A, 700B, and 700C are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of each of SRM server 104, developer server 102, user device 108, and test server 108, which may each include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 is any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing SRMs 114 and 214, data managers 116 and 216, releasers 118, 218, and 418, dashboard managers 120, 220, 320, and 620, software package development processes 112 and 212, testers 128 and 228, developer WebApps 124 and 224, SRM WebApps 126 and 226, data ingester 230, dashboard aggregator 302, data visualizer 304, package comparer 306, inventory manager 308, security manager 310, test manager 312, change log generator 402, compliance checker 404, releaser aggregator 406, notifier 408, package deployer 410, approval manager 412, and security manager 414, and flowcharts 500, 700A, 700B, and 700C (and/or any individual steps thereof).

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 is used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Examples of training inputs for ML model training include user position, angle, gesture, time of day, location, user crypto, etc. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operates application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Further Example Embodiments

Methods, systems, and computer program products are provided for automated software package release management. Software package development, testing, and release information is automatically captured, aggregated, organized, and stored for accessibility and association with released software packages. Automated software package information management increases productivity and accuracy by removing most manual notation tasks from developers, testers, approvers, etc. A software release manager (SRM) may perform automated information collection, aggregation, approval management, compliance checking, change log generation, package compare, package deployment, notification, etc. for multiple software packages. For example, software package information can be distributed in notifications or accessed individually in a user interface. Users can make menu selections or query the software package manager, for example, to automatically and quickly determine and indicate software package-related information, such as the differences between released or unreleased packages, project status, approvals, test results, compliance, component change histories, etc.

In one aspect, a software release manager (SRM) comprises a data manager (e.g., a data ingester and a database) configured to automatically obtain and store information indicative of change, testing, and release of a software package. The SRM includes a releaser configured to automatically generate the information indicative of the release of the software package for each release of the software package. The SRM includes a dashboard manager configured to provide a user interface for an authorized user to access the stored information indicative of change, testing, and release of the software package.

In examples, the SRM includes a notifier configured to automatically notify configured recipients about the information indicative of change, testing, and release of a software package in response to a configured notification trigger.

In examples, the information indicative of change, testing, and release of the software package is indicative of change, testing, and release of components in the software package.

In examples, the software package is developed in a software package development process (e.g., a development pipeline) associated with the SRM. The association comprises hooks in the software package development process causing automated reporting of the information indicative of change of components in the software package to the data manager.

In examples, the releaser comprises an approval manager configured to automatically manage the release of the software package comprising managing an approval process to obtain approval of the software package from the configured recipients.

In examples, the releaser comprises a compliance checker configured to automatically determine whether components in the software package comply with configured release criteria (e.g., code query language (QL), flighting compliance, symbol checking, code QL static analysis, configuration (INF file) verifier).

In examples, the releaser comprises a change log generator configured to automatically maintain a history of changes to components in the software package.

In examples, the dashboard manager comprises a package comparer configured to automatically determine differences between components in different released or pre-released software packages or in different releases of the same software package.

In examples, the dashboard manager comprises an aggregator configured to automatically combine information about each component in the software package received from multiple sources or at different times.

In examples, the releaser comprises a package deployer configured to automatically deploy the released software package to configured destinations.

In examples, the data manager is configured to automatically obtain and store information indicative of change, testing, and release of each of a plurality of software packages. The releaser is configured to automatically generate the information indicative of the release of each of the plurality of software packages for each release of each of the plurality of software packages. The dashboard manager is configured to provide a user interface for an authorized user to access the stored information indicative of change, testing, and release of each of the plurality of software packages.

In another aspect, a method comprises automatically obtaining and storing information (e.g., providing a data manager configured to) indicative of change, testing, and release of each of a plurality of software packages; (e.g., providing a releaser configured to) automatically generating the information indicative of the release of each of the plurality of software packages for each release of each of the plurality of software packages; and (e.g., providing a dashboard user interface configured to) presenting users with the stored information indicative of change, testing, and release of each of the plurality of software packages.

In examples, the method further comprises automatically notifying (e.g., providing a notifier configured to notify) configured recipients about the information indicative of change, testing, and release of each of the plurality of software packages in response to a configured notification trigger.

In examples, the information indicative of change, testing, and release of each of the plurality of software packages is indicative of change, testing, and release of components in each of the plurality of software packages.

In examples, each of the plurality of software packages is developed in a software package development process associated with the SRM. The association comprises hooks in the software package development process causing automated reporting of the information indicative of change of components in each of the plurality of software packages to the data manager.

In examples, the method further comprises automatically managing (e.g., providing an approval manager configured to manage) the release of each of the plurality of software packages comprising managing an approval process to obtain approval of each of the plurality of software packages from the configured recipients.

In examples, the method further comprises automatically determining (e.g., providing a compliance checker configured to determine) whether components in each of the plurality of software packages comply with configured release criteria.

In examples, the method further comprises automatically maintaining (e.g., providing a change log generator configured to maintain) a history of changes to components in each of the plurality of software packages.

In examples, the method further comprises automatically determining (e.g., providing a package comparer configured to determine) differences between components in different released or pre-released software packages or in different releases of the same software package among the plurality of software packages.

In examples, the method further comprises automatically combining (e.g., providing an aggregator configured to combine) information about each component in each of the plurality of software packages received from multiple sources or at different times.

In examples, the method further comprises automatically deploying (e.g., providing a package deployer configured to deploy) the released software package to configured destinations.

In another aspect, a computer-readable storage medium may have program instructions recorded thereon that, when executed by a processing circuit, perform a method. The method may comprise any method described herein.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the claimed embodiments should not be limited by any of the above-described exemplary embodiments, but should be defined only in accordance with the following claims and their equivalents.

What is claimed is:

1. A software release manager (SRM) implemented in a computing device, the SRM comprising:
a data manager configured to automatically obtain and store information indicative of change, testing, and release of a software package;
a releaser configured to automatically generate the information indicative of the release of the software package for each release of the software package; and
a dashboard manager configured to provide a user interface for an authorized user to access the stored information indicative of change, testing, and release of the software package.

2. The SRM of claim 1, the SRM further comprising:
a notifier configured to automatically notify configured recipients about the information indicative of change, testing, or release of the software package in response to a configured notification trigger.

3. The SRM of claim 1, wherein the information indicative of change, testing, and release of the software package is indicative of change, testing, and release of components in the software package.

4. The SRM of claim 1, wherein the software package is developed in a software package development process associated with the SRM; and
wherein the association comprises hooks in the software package development process causing automated reporting of the information indicative of change of components in the software package to the data manager.

5. The SRM of claim 1, wherein the releaser comprises an approval manager configured to automatically manage the release of the software package comprising managing an approval process to obtain approval of the software package from the configured recipients.

6. The SRM of claim 1, wherein the releaser comprises a compliance checker configured to automatically determine whether components in the software package comply with configured release criteria.

7. The SRM of claim 1, wherein the releaser comprises a change log generator configured to automatically maintain a history of changes to components in the software package.

8. The SRM of claim 1, wherein the dashboard manager comprises a package comparer configured to automatically determine differences between components in different released or pre-released software packages or in different releases of the same software package.

9. The SRM of claim 1, wherein the dashboard manager comprises an aggregator configured to automatically combine information about each component in the software package received from multiple sources or at different times.

10. The SRM of claim 1, wherein the releaser comprises a package deployer configured to automatically deploy the released software package to configured destinations.

11. The SRM of claim 1, wherein the data manager is configured to automatically obtain and store information indicative of change, testing, and release of each of a plurality of software packages;
wherein the releaser is configured to automatically generate the information indicative of the release of each of the plurality of software packages for each release of each of the plurality of software packages; and
wherein the dashboard manager is configured to provide a user interface for an authorized user to access the stored information indicative of change, testing, and release of each of the plurality of software packages.

12. A computer-implemented method comprising:
automatically obtaining and storing information indicative of change, testing, and release of each of a plurality of software packages;
automatically generating the information indicative of the release of each of the plurality of software packages for each release of each of the plurality of software packages; and
providing a user interface that presents users with the stored information indicative of change, testing, and release of each of the plurality of software packages.

13. The computer-implemented method of claim 12, further comprising:
automatically notifying configured recipients about the information indicative of change, testing, and release of each of the plurality of software packages in response to a configured notification trigger.

14. The computer-implemented method of claim 12, wherein the information indicative of change, testing, and release of each of the plurality of software packages is indicative of change, testing, and release of components in each of the plurality of software packages.

15. The computer-implemented method of claim 12, wherein each of the plurality of software packages is developed in a software package development process associated with the SRM; and
wherein the association comprises hooks in the software package development process causing automated reporting of the information indicative of change of components in each of the plurality of software packages to the data manager.

16. The computer-implemented method of claim 12, further comprising:
automatically managing the release of each of the plurality of software packages comprising managing an approval process to obtain approval of each of the plurality of software packages from the configured recipients.

17. The computer-implemented method of claim 12, further comprising:
automatically determining whether components in each of the plurality of software packages comply with configured release criteria.

18. The computer-implemented method of claim 12, further comprising:
automatically maintaining a history of changes to components in each of the plurality of software packages.

19. The computer-implemented method of claim 12, further comprising:
automatically determining differences between components in different released or pre-released software packages or in different releases of the same software package among the plurality of software packages.

20. The computer-implemented method of claim 12, further comprising:
automatically combining information about each component in each of the plurality of software packages received from multiple sources or at different times.
